(19) United States
(12) Patent Application Publication
(10) Pub. No.: US 2025/0376827 A1
(43) Pub. Date: Dec. 11, 2025

(54) COUPLING DEVICE FOR A TOOL

(71) Applicant: MECCANICA BREGANZESE S.P.A. IN FORMA ABBREVIATA MB S.P.A., Fara Vicentino (VI) (IT)

(72) Inventors: Diego AZZOLIN, Fara Vicentino (VI) (IT); Guido AZZOLIN, Breganze (VI) (IT)

(73) Assignee: MECCANICA BREGANZESE S.P.A. IN FORMA ABBREVIATA MB S.P.A., Fara Vicentino (VI) (IT)

(21) Appl. No.: 19/232,903

(22) Filed: Jun. 10, 2025

(30) Foreign Application Priority Data
Jun. 11, 2024 (IT) 102024000013366

(51) Int. Cl. E02F 3/36; E02F 3/40

(52) U.S. Cl. CPC E02F 3/3677; E02F 3/404

(57) ABSTRACT

In a coupling device for a tool that is couplable to a self-propelled vehicle, the coupling device includes a main frame, a connection device to a coupling element of the self-propelled vehicle, a translationally movable support body which is configured to support the tool in a work position. The translationally movable support body being mounted on the main frame in a translationally movable manner in a translation direction. The coupling device also including a movement mechanism for the translationally movable support body. The movement mechanism includes a transmission chain or belt which is wrapped around a pair of rotating transmission elements and which is connected to the translationally movable support body in such a manner as to move the translationally movable support body in the translation direction.

### CROSS REFERENCE TO RELATED APPLICATIONS

The present application claims the benefit of priority to Italian Patent Application No. 102024000013366, filed on Jun. 11, 2024, the entire contents of which are incorporated in this application by reference.

### TECHNICAL FIELD

The present disclosure relates to a coupling device for a tool, such as a pincer or a milling cutter, of the type comprising a main frame and a connection device to a coupling element of a self-propelled vehicle, for example a preferably compact loader.

### BACKGROUND

In the technical field of reference, it is known to use compact loaders, also known as skid loaders, as vehicles for the execution of various types of workings through the application of special tools.

For example, these vehicles are used in the execution of road works through the application of rotating milling cutters, or for shredding or material handling works using special pincers.

These tools are typically fixed to the arms of the loader, thereby allowing to perform lifting and lowering movements of the tools.

However, the arms of these vehicles are not normally provided with lateral movement, i.e. horizontal, and, consequently, tool attachment systems are used which also allow a horizontal movement thereof.

However, the known attachment systems have the disadvantage of not allowing the movement of the tool along the entire width of the loader, limiting the operation of the equipment item in the case of workings close to walls, curbs or any type of obstacle that does not allow the approach of the carrying means.

In fact, the known attachment systems are configured in a manner that they do not extend beyond the lateral encumbrance of the vehicle, since in such applications the possibility of having compact dimensions, so as to guarantee the required handling, is particularly important.

However, the presence of the members responsible for moving the tool in a horizontal direction limits the useful stroke provided by the known attachment systems.

This problem can be observed, for example, in the solution described in British patent application GB2512945A, in which a linear actuator is used to move a milling cutter along a horizontal guide.

The linear actuator is in fact arranged parallel to the guide and for obvious technical reasons, the stroke of the actuator cannot cover the entire encumbrance of the actuator.

A further solution is described in U.S. Pat. No. 4,262,966A which provides for the use of a screw actuator responsible for the horizontal movement of a milling cutter.

Although this solution allows a greater stroke in relation to the overall size of the movement system, it allows a rather limited movement speed. In addition, the screw actuator is an expensive and delicate component that does not lend itself well to applications particularly exposed to dust, such as road workings.

In fact, the screw actuator can be easily damaged by the presence of dirt and dust which, for obvious reasons, are present in significant quantity during the milling operations of the asphalt or of other surfaces.

Further examples of coupling devices are known from US20220007560A1 or WO2017177014A1.

### SUMMARY

An object the present disclosure is to provide a coupling device for a tool, such as a pincer or a milling cutter, which can be applied to self-propelled vehicles and which is structurally and functionally designed to overcome, at least in part, one or more of the drawbacks complained of with reference to the cited prior art.

Within the scope of this problem, another object of the present disclosure is to provide a coupling device that allows to move the tool with a continuous force at constant speed during displacement.

A further object of the present disclosure is to provide a coupling device capable of improving the maneuverability and stability of the vehicle to which it is applied.

Another object of the present disclosure is to provide a coupling device that allows an adequate movement capacity of the tool in a solution of contained dimensions.

A further object is to provide a coupling device capable of moving the tool in a horizontal direction for a stroke that is substantially equal to the entire extension in this direction of the coupling device.

This problem is solved and these objects are at least in part achieved by the disclosure by a coupling device for a tool, such as a pincer or a milling cutter or an equipment item, which is applicable to self-propelled vehicles, comprising a main frame which preferably mainly develops in two dimensions defining a main location plane.

The coupling device further comprises a connection device to a coupling element of the self-propelled vehicle and a translationally movable support body which is configured to support the tool in a work position.

Preferably, the support body is mounted on the main frame in a translationally movable manner in a translation direction.

The coupling device preferably comprises a movement mechanism for the support body.

The movement mechanism preferably comprises a transmission chain or belt which is wrapped around a pair of rotating transmission elements. The transmission chain or belt is advantageously connected to the translationally movable support body in such a manner as to move the translationally movable support body in the translation direction.

It will be appreciated that the presence of the chain or belt mechanism allows the tool to be moved with a continuous force at constant speed for the entire extension of the coupling device.

The rotating transmission elements are preferably associated with the main frame in a rotatable manner about respective rotation axes. Advantageously, said rotation axes belong to a second location plane which is substantially perpendicular the main location plane and preferably substantially parallel with the translation direction.

It will be appreciated that the arrangement of the rotation axes of the rotating elements on a plane which is substantially perpendicular to that of the main frame allows to obtain a compact structure that reduces the frontal encumbrance of the vehicle to which it is applied, to the advantage of the manoeuvrability and stability of the vehicle itself.

The present disclosure may also have one or more of the following further preferred features.

It is preferred that the movement mechanism comprises a rotary actuator. It is further preferred that the rotating transmission elements comprise a first rotating element which is associated with said rotary actuator and a second rotating element which is idly supported on the main frame. These preferred features allow the movement mechanism to be made in a simple way, thus guaranteeing high reliability.

It is preferred that the main frame has a substantially rectangular shape comprising a pair of opposite flanks. It is further preferred that said substantially rectangular shape is delimited by said pair of opposite flanks and by a pair of sides, also opposite, said sides preferably being substantially perpendicular to said flanks.

In some embodiments, the rotating transmission elements are associated with the main frame in a position adjacent to one of said flanks and in a position adjacent to the other of said flanks, respectively. This feature further allows to increase the distance that the stroke of the rotary actuator allows the support body to travel.

In a preferred example, the main frame comprises a housing inside which there are received the transmission chain or belt and possibly also the pair of rotating transmission elements. In this way the transmission mechanism is protected from dust and dirt. Advantageously, the housing is delimited by the pair of flanks and possibly by at least one of the sides of the pair of sides. This structure is particularly advantageous for its compactness.

In embodiments, at least one of the sides of the pair of sides (preferably the same side delimiting the housing) comprises a guide element along which the translationally movable support body moves in translation. This feature also makes it possible to optimize the overall dimensions of the coupling device.

In a preferred example, the translationally movable support body is mounted on the main frame at the opposite side to the connection device. In this way it is possible to realize the coupling device and the relative movement mechanism through a simple and rational structure.

In embodiments, the rotating transmission elements are separated by a distance in the translation direction, the coupling device preferably comprising an adjustment system which is configured to adjust said distance. These features facilitate the assembly of the transmission chain or belt and allow to optimize the stroke that the support body can travel.

In embodiments, said transmission chain or belt comprises at least one portion which is extended from one of the rotating transmission elements to the other rotating transmission element in a direction substantially parallel with the translation direction. Advantageously, the translationally movable support body is coupled to the transmission chain or belt in the region of said portion. In this way the support body can be towed by the transmission chain or belt between a position close to a rotating element and a position close to the other rotating element.

In a preferred example, the housing comprises a slot which is extended in the translation direction to allow the passage of a fixing device by which the translationally movable support body is coupled to the transmission chain or belt.

Preferably, the translationally movable support body mainly develops in two dimensions defining a respective location plane substantially parallel with the main location plane. This feature also contributes to a compact structure that reduces the front protrusion of the tool from the vehicle and thus improves the maneuverability and stability of the vehicle.

In some embodiments the translationally movable support body comprises a plate in the region of which the tool is mounted. Thanks to the presence of the plate, it is possible to mount the tool in a simple and particularly stable way. At the same time, the plate lends itself particularly well to the translation on the frame.

Further preferred aspects are also defined in the appended claims as well as by the following description.

In this description as well as in the accompanying claims, and more in general in the context of the present disclosure, certain terms and expressions are deemed to have, unless otherwise expressly indicated, the meaning expressed in the following definitions.

In particular, the expression “mainly develops in two dimensions” referred to the main frame means that the main frame has two main dimensions, i.e. larger than the third dimension. This, however, does not exclude that the main frame may have a certain depth along the third dimension, i.e. orthogonally to the two main dimensions.

With the term “substantially rectangular” referred to the shape of an object, it will be understood that this has at least one portion that reminds a rectangle or a square. Preferably, in an object that has two main dimensions with respect to the other, this portion coincides with that defined by the two larger dimensions. The sides/flanks of the rectangle must not necessarily be regular, since it is contemplated that there are elements that protrude or recess with respect to perfectly straight sides/flanks.

With the term “substantially parallel” referred to two directions/planes, it is understood that said directions/planes are parallel to each other or deviate from a perfect parallelism preferably by a maximum of 10 degrees and even more preferably 5 degrees.

With the term “substantially perpendicular” referred to two directions/planes, it is understood that said directions/planes are perpendicular to each other or deviate from a perfect perpendicularity preferably by a maximum of 10 degrees and even more preferably 5 degrees.

### BRIEF DESCRIPTION OF THE DRAWINGS

The characteristics and advantages of the disclosure will become clearer from the detailed description of preferred embodiments thereof, by way of non-limiting example, with reference to the appended drawings wherein:

FIG. 1 is a side view of a vehicle to which a pincer-type tool is mounted through a coupling device according to the present disclosure;

FIG. 2 is a perspective view of the coupling device of the present disclosure;

FIG. 3 is a perspective view, from the rear, of the coupling device according to the present disclosure;

FIG. 4 is a perspective view, from the rear, of the coupling device of the present disclosure in which some details have been omitted for greater clarity of illustration;

FIG. 5 is a perspective view of the coupling device of the present disclosure in which some details have been omitted for greater clarity of illustration; and

FIG. 6 is a perspective view, from the rear, of a detail of the coupling device of the present disclosure in which some details have been omitted for greater clarity of illustration.

### DETAILED DESCRIPTION OF THE PREFERRED EMBODIMENTS

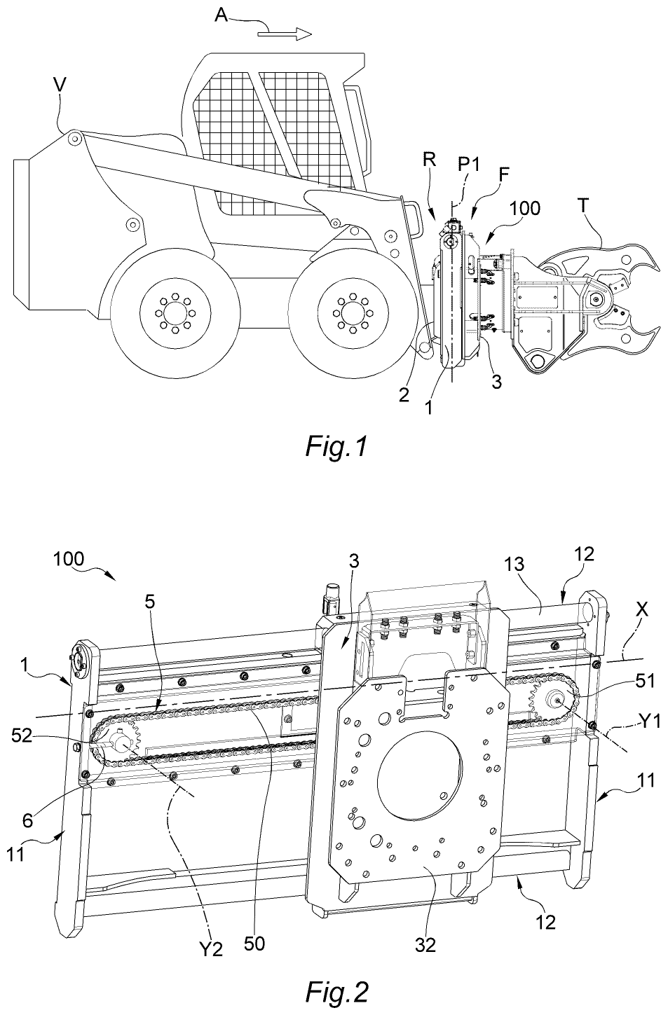

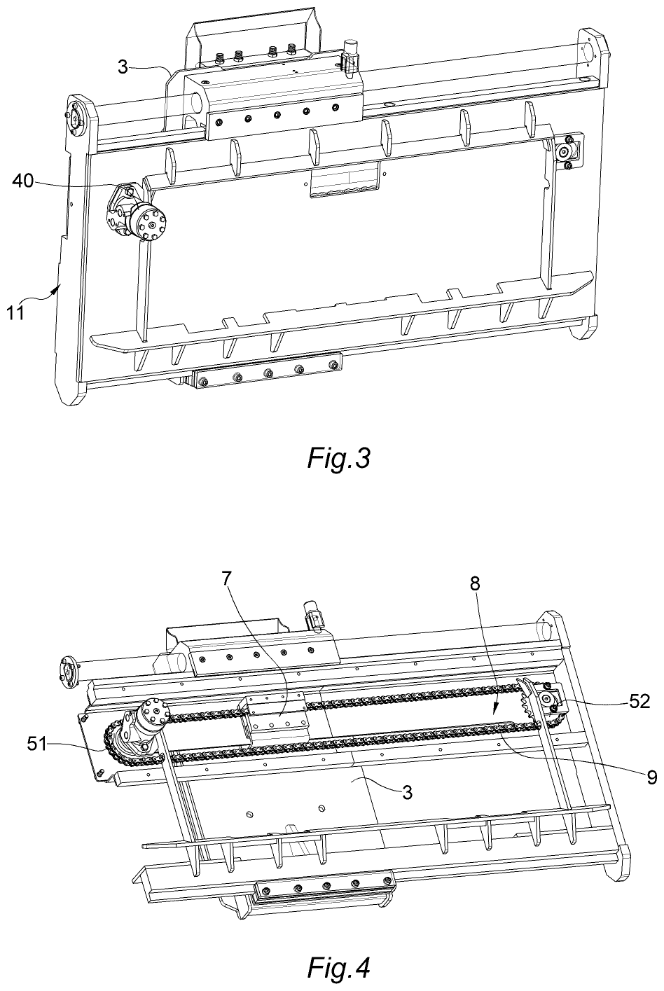

With reference initially to the example of FIG. 1, a coupling device for a tool T is indicated overall with the reference numeral 100.

In the exemplary embodiment illustrated in the figures, the coupling device 100 is used to apply a pincer to a compact loader or skid loader.

It is however evident that the coupling device according to the present disclosure can be used to apply a pincer or other types of tools to self-propelled vehicles V of any type.

The coupling device 100 comprises a main frame 1 which preferably mainly develops in two dimensions defining a main location plane P1.

In embodiments, the coupling device 100 also comprises a connection device 2 that allows it to be connected to a relative coupling element of the self-propelled vehicle V, for example represented by the arms on which the loader is normally supported.

The coupling device 100 further comprises a translationally movable support body 3 on which the tool T is supported in a relative work position.

For example, as can be observed from the FIG. 1, in the case of a compact loader the tool is placed so as to extend longitudinally in front of the vehicle, so that it can be used for workings of various type.

Preferably, the connection device 2 and at least one main portion of the translationally movable support body 3 belong to respective parts R, F of the device 100 that are opposite with respect to the plane P1 on which the frame 1 is located. In particular, with respect to a direction of travel A of the vehicle, the plane P1 on which the frame 1 is located divides the coupling device 100 into a rear part R to which the connection device 2 preferably belongs and a front part F to which at least a main part of the translationally movable support body 3 preferably belongs.

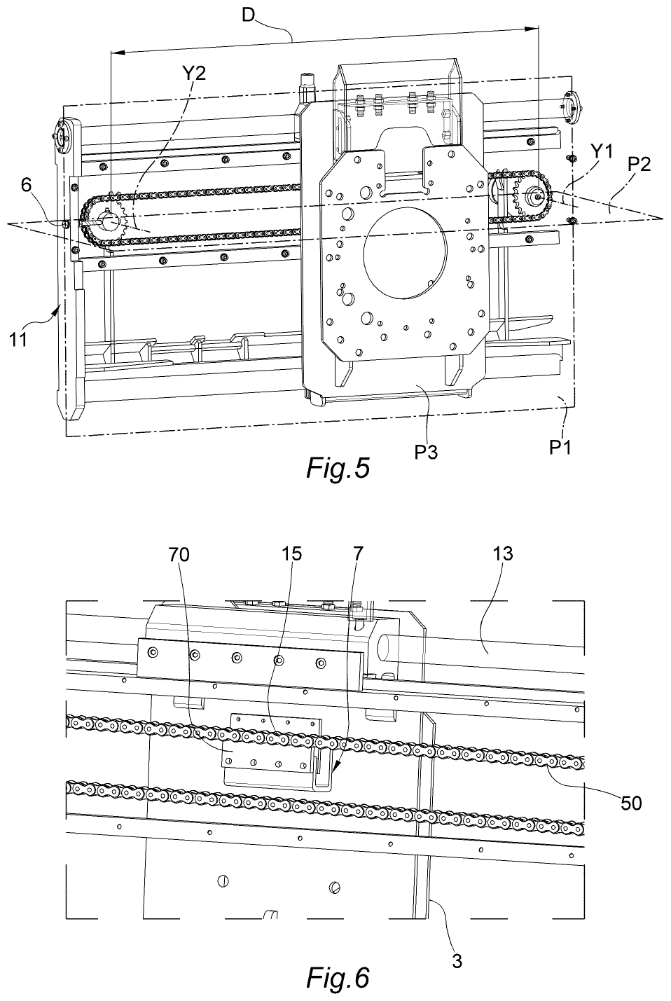

In embodiments, the translationally movable support body 3 mainly develops in two dimensions defining a respective location plane P3 which is substantially parallel with the main location plane P1, as shown in the example of FIG. 5. Preferably, the translationally movable support body 3 comprises a plate 32 in the region of which the tool T is mounted. In a preferred example, the plate 32 is substantially parallel with the location plane P3.

As can be better observed from the example of FIG. 2, the support body 3 is mounted on the main frame 1 in a translationally movable manner in a translation direction X. For this purpose, the frame 1 may comprise a guide element 13, in particular a linear guide element, along which the translationally movable support body 3 moves in translation.

The movement of the support body 3 is carried out by a special movement mechanism 4. The movement mechanism 4 preferably comprises a rotary actuator 40 which is constrained to the main frame 1 and a towed driven transmission mechanism, in particular a chain or belt mechanism 5, by which the rotary actuator 40 is connected to the translationally movable support body 3 in such a manner as to move the support body 3 in the translation direction X.

Preferably, the rotary actuator 40 comprises a shaft driven in rotation by a motor, in particular a hydraulic or electric motor.

Preferably, the chain or belt mechanism 5 is arranged in a position that is adjacent to the guide element 13.

In embodiments, the chain or belt mechanism 5 comprises a transmission chain or belt 50 which is wrapped around rotating transmission elements 51, 52 which are associated with the main frame.

In a preferred example, the rotating transmission elements 51, 52 include toothed wheels cooperating with a transmission chain. Alternatively, the rotating transmission elements may include pulleys, preferably of the splined type, cooperating with a transmission belt, preferably of the toothed type.

The rotating transmission elements preferably comprise a first rotating element 51 which is axially fitted on the shaft of the rotary actuator 40 and a second rotating element 52 which is idly supported on the main frame.

The rotating elements 51, 52 have respective rotation axes Y1, Y2. It is preferred that said rotation axes belong to a second location plane P2. As shown in the example of FIG. 5, the second location plane P2 is preferably substantially perpendicular the main location plane P2 and substantially parallel with the translation direction X.

The rotating elements 51, 52 are preferably separated by a distance D in the translation direction X. In embodiments, the device 100 comprises an adjustment system 6 which is configured to adjust the distance D between the rotating transmission elements in the translation direction X. The adjustment system 6 may for example include an adjustment screw interposed between a flank 11 of the frame and the axis Y2 of one of the rotating elements in such a manner that the rotation of the screw modifies the position of the axis.

In embodiments, as shown in the examples of FIGS. 4 and 6, the translationally movable support body 3 is coupled to the transmission chain or belt 50 by a fixing device 7. Preferably, the fixing device 7 is associated with the transmission chain or belt 50 in an intermediate position between the rotating transmission elements 51, 52. In this way, the support body 3 can be towed by the transmission chain or belt 50 between a position close to one of the rotating elements and a position close to the other rotating element.

In embodiments, the transmission chain or belt 50 comprises at least one portion 15 which is substantially parallel with the translation direction X. It is preferred that the fixing device 7 is fixed to said portion 15. The portion 15 preferably concerns a main portion of the longitudinal development of the transmission chain or belt 50.

To facilitate assembly and maintenance of the device 100 it is preferred that the fixing device 7 is releasable. In a preferred example, the fixing device 7 comprises a toothed element 70 which engages in the links of the transmission chain. In particular, the links of the transmission chain are retained between the toothed element and a flanged element bolted to the toothed element.

In embodiments, the main frame 1 comprises a housing 8 inside which the chain or belt mechanism 5 is received. Preferably, the housing 8 comprises a slot 9 which is extended in the translation direction X to allow the passage of the fixing device 7.

The frame 1 is preferably extended in the translation direction X. During the movement, the support body 3 is moved in translation between a position close to a first end of the frame and a position close to the opposite end.

Preferably, the frame 1 has a substantially rectangular shape comprising a pair of opposite flanks 11 corresponding to the aforementioned ends. The flanks 11 are preferably substantially perpendicular to the translation direction X. In embodiments the substantially rectangular shape of the frame is delimited by said pair of opposite flanks 11 and by a pair of sides 12, also opposite, said sides 12 preferably being substantially perpendicular to said flanks 11.

The housing 8 is preferably delimited by said pair of flanks 11 and possibly by one of said sides 12.

At least one of the sides 12 of the frame, preferably the same side that delimits the housing 8, comprises the guide element 13 along which the support body 3 moves in translation. It is understood that, in embodiments, the guide element 13 can concern both sides 12 of the frame, in such a manner as to confer greater stability to the support body 3.

In embodiments, the rotating transmission elements 51, 52 are rotatably associated with the main frame 1 adjacent to one and the other of said flanks 11, respectively.

In embodiments, the rotary actuator 40 is constrained to the main frame 1 in the region of the first rotating element 51, preferably at the opposite side to the support body 3.

In embodiments, the adjustment system 6 acts on the second rotating element 52 and is preferably associated with the flank 11 adjacent to the second rotating element 52.

The disclosure thus achieves the proposed objectives while also achieving numerous advantages over the prior art of reference, including a high movement capacity, in the context of a solution with contained overall encumbrances, which is rational and with relatively low construction costs.

Although illustrated and described above with reference to certain specific embodiments, the present disclosure is nevertheless not intended to be limited to the details shown. Rather, various modifications may be made in the details within the scope and range of equivalents of the claims and without departing from the spirit of the disclosure.

What is claimed is:

1. A coupling device for a tool, which is couplable to a self-propelled vehicle, the coupling device comprising:
a main frame which essentially develops in two dimensions which define a main location plane;
a connection device to a coupling element of said self-propelled vehicle;
a translationally movable support member which is configured to support the tool in a work position, said translationally movable support member being mounted on said main frame in a translationally movable manner in a translation direction;
a movement mechanism for said translationally movable support body, wherein said movement mechanism comprises a transmission chain or belt which is wrapped around a pair of rotating transmission elements and which is connected to said translationally movable support body in such a manner as to move said translationally movable support body in said translation direction,
wherein said rotating transmission elements are associated with said main frame in a rotatable manner about respective rotation axes, said rotation axes belonging to a second location plane which is substantially perpendicular to said main location plane and substantially parallel with said translation direction.

2. The coupling device according to claim 1, wherein said movement mechanism comprises a rotary actuator and wherein said rotating transmission elements comprise a first rotating element which is associated with said rotary actuator and a second rotating element which is idly supported on said main frame.

3. The coupling device according to claim 1, wherein said main frame has a substantially rectangular shape comprising a pair of opposite flanks, said rotating transmission elements being associated with said main frame in a position adjacent to one of said flanks and in a position adjacent to the other of said flanks, respectively.

4. The coupling device according to claim 3, wherein said main frame comprises a housing inside which there are received said transmission chain or belt and said pair of rotating transmission elements, said housing being delimited by said pair of flanks.

5. The coupling device according to claim 3, wherein said substantially rectangular shape is delimited by said pair of opposite flanks and by a pair of opposite sides, said opposite sides being substantially perpendicular to said flanks, wherein at least one of said opposite sides comprises a guide element along which said translationally movable support body moves in translation.

6. The coupling device according to claim 1, wherein said translationally movable support body is mounted on said main frame at a side opposite to said connection device.

7. The coupling device according to claim 1, wherein said rotating transmission elements are separated by a distance in said translation direction, said coupling device comprising an adjustment system which is configured to adjust said distance.

8. The coupling device according to claim 1, wherein said transmission chain or belt comprises at least one portion which is extended from one of said rotating transmission elements to the other rotating transmission element in a direction substantially parallel with said translation direction, said translationally movable support body being coupled to said transmission chain or belt in the region of said portion.

9. The coupling device according to claim 1, wherein said translationally movable support body essentially develops in two dimensions which define a respective location plane which is substantially parallel with said main location plane.

10. The coupling device according to claim 1, wherein said translationally movable support member comprises a plate, in a region of which the tool is mounted.

11. The coupling device according to claim 2, wherein said main frame has a substantially rectangular shape comprising a pair of opposite flanks, said rotating transmission elements being associated with said main frame in a position adjacent to one of said flanks and in a position adjacent to the other of said flanks, respectively.

12. The coupling device according to claim 11, wherein said main frame comprises a housing inside which there are received said transmission chain or belt and said pair of rotating transmission elements, said housing being delimited by said pair of flanks.

13. The coupling device according to claim 11, wherein said substantially rectangular shape is delimited by said pair of opposite flanks and by a pair of sides, also opposite, said sides being substantially perpendicular to said flanks, wherein at least one of said sides comprises a guide element along which said translationally movable support body moves in translation.

14. The coupling device according to claim 4, wherein said substantially rectangular shape is delimited by said pair of opposite flanks and by a pair of opposite sides, said opposite sides being substantially perpendicular to said flanks, wherein at least one of said opposite sides comprises a guide element along which said translationally movable support body moves in translation.

15. The coupling device according to claim 7, wherein said transmission chain or belt comprises at least one portion which is extended from one of said rotating transmission elements to the other rotating transmission element in a direction substantially parallel with said translation direction, said translationally movable support body being coupled to said transmission chain or belt in the region of said portion.

16. A coupling device for a tool, which is couplable to a self-propelled vehicle, the coupling device comprising:
a main frame which essentially develops in two dimensions which define a main location plane;
a connection device to a coupling element of said self-propelled vehicle;
a translationally movable support member which is configured to support the tool in a work position, said translationally movable support member being mounted on said main frame in a translationally movable manner in a translation direction;
a movement mechanism for said translationally movable support body, wherein said movement mechanism comprises a transmission chain or belt which is wrapped around a pair of rotating transmission elements and which is connected to said translationally movable support body in such a manner as to move said translationally movable support body in said translation direction,
wherein said rotating transmission elements are associated with said main frame in a rotatable manner about respective rotation axes, said rotation axes belonging to a second location plane which is substantially perpendicular to said main location plane and substantially parallel with said translation direction, wherein said movement mechanism comprises a rotary actuator and wherein said rotating transmission elements comprise a first rotating element which is associated with said rotary actuator and a second rotating element which is idly supported on said main frame, wherein said main frame has a substantially rectangular shape comprising a pair of opposite flanks, said rotating transmission elements being associated with said main frame in a position adjacent to one of said flanks and in a position adjacent to the other of said flanks, respectively, wherein said main frame comprises a housing inside which there are received said transmission chain or belt and said pair of rotating transmission elements, said housing being delimited by said pair of flanks.

17. The coupling device according to claim 16, wherein said substantially rectangular shape is delimited by said pair of opposite flanks and by a pair of opposite sides, said opposite sides being substantially perpendicular to said flanks, wherein at least one of said opposite sides comprises a guide element along which said translationally movable support body moves in translation.

18. The coupling device according to claim 16, wherein said translationally movable support body is mounted on said main frame at the opposite side to said connection device.

19. The coupling device according to claim 16, wherein said rotating transmission elements are separated by a distance in said translation direction, said coupling device comprising an adjustment system which is configured to adjust said distance.

20. A coupling device for a tool, which is couplable to a self-propelled vehicle, the coupling device comprising:
a main frame which essentially develops in two dimensions which define a main location plane;
a connection device to a coupling element of said self-propelled vehicle;
a translationally movable support member which is configured to support the tool in a work position, said translationally movable support member being mounted on said main frame in a translationally movable manner in a translation direction;
a movement mechanism for said translationally movable support body, wherein said movement mechanism comprises a transmission chain or belt which is wrapped around a pair of rotating transmission elements and which is connected to said translationally movable support body in such a manner as to move said translationally movable support body in said translation direction,
wherein said rotating transmission elements are associated with said main frame in a rotatable manner about respective rotation axes, said rotation axes belonging to a second location plane which is substantially perpendicular to said main location plane and substantially parallel with said translation direction, wherein said movement mechanism comprises a rotary actuator and wherein said rotating transmission elements comprise a first rotating element which is associated with said rotary actuator and a second rotating element which is idly supported on said main frame, wherein said main frame has a substantially rectangular shape comprising a pair of opposite flanks, said rotating transmission elements being associated with said main frame in a position adjacent to one of said flanks and in a position adjacent to the other of said flanks, respectively, wherein said main frame comprises a housing inside which there are received said transmission chain or belt and said pair of rotating transmission elements, said housing being delimited by said pair of flanks, wherein said substantially rectangular shape is delimited by said pair of opposite flanks and by a pair of sides, also opposite, said sides being substantially perpendicular to said flanks, wherein at least one of said sides comprises a guide element along which said translationally movable support body moves in translation.
